(19) United States
(12) Patent Application Publication
(10) Pub. No.: US 2024/0180208 A1
(43) Pub. Date: Jun. 6, 2024

(54) FOOD MANUFACTURING METHOD, FOOD TEMPERATURE-REGULATING METHOD, FOOD MANUFACTURING APPARATUS AND PROGRAM

(71) Applicant: NICHIREI FOODS INC., Tokyo-to (JP)

(72) Inventors: Ryuichi ITOU, Tokyo-to (JP); Takuya MATSUSHITA, Tokyo-to (JP); Minoru MAMIYA, Tokyo-to (JP)

(73) Assignee: NICHIREI FOODS INC., Tokyo-to (JP)

(21) Appl. No.: 18/283,755

(22) PCT Filed: Mar. 10, 2022
(86) PCT No.: PCT/JP2022/010518

§ 371 Date: Sep. 22, 2023

(30) Foreign Application Priority Data
Mar. 25, 2021 (JP) 2021-052217

(51) Int. Cl. A23L 5/10; A21B 1/40; A21B 1/48

(52) U.S. Cl. CPC A23L 5/15; A21B 1/40; A21B 1/48

(57) ABSTRACT

A food manufacturing method includes: a temperature-regulating control preparation step of supplying a food ingredient continuously to a moving section during the moving section moving cyclically along a movement path for one or more cycles in a state where adjustment of temperature of the moving section is not performed; and a food ingredient temperature-regulating processing step of supplying the food ingredient continuously to the moving section, after the temperature-regulating control preparation step, in a state where a temperature-regulating control processing to adjust the temperature of the moving section based on a target temperature-regulating temperature range by a temperature-regulating device is placed in an on state.

### TECHNICAL FIELD

The present disclosure relates to a food manufacturing method, a food temperature-regulating method, a food manufacturing apparatus, and a program.

### BACKGROUND ART

A device is known that uses a baking drum to heat a pasty food ingredient, such as batter, so as to continuously manufacture thin-skinned baked food products.

A skin-shaped food product manufacturing apparatus disclosed in Patent Literature 1 comprises: a baking drum that is heated by a built-in heater and rotates at low speed; and a heating means that heats an end of the outer circumference surface of the baking drum, thereby seeking to achieve uniformization of the temperature distribution of the outer circumference surface of the baking drum.

### CITATION LIST

### Patent Literature

Patent Literature 1: Japanese patent application publication No. 2014-11982

### SUMMARY OF INVENTION

In cases where a food ingredient is heated by using a heating cooking device such as a baking drum, it takes time from starting the operation of the heating cooking device until a food ingredient can be heated stably in a desired state.

For instance, in cases where a paste-like food ingredient is baked, even if a drum baking surface once reaches an ideal baking temperature, the temperature of the baking drum may drop locally due to the supplying of a paste-like food ingredient, causing a large temperature difference between areas of the drum baking surface. When a large temperature difference occurs between areas of the drum baking surface, the uniform baking of a food ingredient cannot be stably carried out, and it takes time to uniformize the temperature of the drum baking surface enough to bake a food ingredient in a stable manner.

The present disclosure has been contrived in view of the above-described circumstances and has an object of providing a technology advantageous to performing a temperature-regulating processing of a food ingredient in a stable manner.

One aspect of the present disclosure is directed to a food manufacturing method including: a temperature-regulating control preparation step of supplying a food ingredient continuously to a moving section during the moving section moving cyclically along a movement path for one or more cycles in a state where adjustment of temperature of the moving section is not performed; and a food ingredient temperature-regulating processing step of supplying the food ingredient continuously to the moving section, after the temperature-regulating control preparation step, in a state where a temperature-regulating control processing to adjust the temperature of the moving section based on a target temperature-regulating temperature range by a temperature-regulating device is placed in an on state.

Another aspect of the present disclosure is directed to a food temperature-regulating method including: a temperature-regulating control preparation step of supplying a food ingredient continuously to a moving section during the moving section moving cyclically along a movement path for one or more cycles in a state where adjustment of temperature of the moving section is not performed; and a food ingredient temperature-regulating processing step of supplying the food ingredient continuously to the moving section, after the temperature-regulating control preparation step, in a state where a temperature-regulating control processing to adjust the temperature of the moving section based on a target temperature-regulating temperature range by a temperature-regulating device is placed in an on state.

Another aspect of the present disclosure is directed to a food manufacturing apparatus comprising: a moving section; a temperature-regulating device that adjusts temperature of the moving section; a food ingredient supply device that supplies a food ingredient to the moving section; and a temperature-regulating control device that controls the temperature-regulating device, wherein the temperature-regulating control device controls the temperature-regulating device to perform: a temperature-regulating control preparation step of supplying the food ingredient continuously to the moving section during the moving section moving cyclically along a movement path for one or more cycles in a state where adjustment of temperature of the moving section by the temperature-regulating device is not performed; and a food ingredient temperature-regulating processing step of supplying the food ingredient continuously to the moving section, after the temperature-regulating control preparation step, in a state where a temperature-regulating control processing to adjust the temperature of the moving section based on a target temperature-regulating temperature range by the temperature-regulating device is placed in an on state.

Another aspect of the present disclosure is directed to a program for causing a computer to execute: a temperature-regulating control preparation procedure of supplying a food ingredient continuously to a moving section during the moving section moving cyclically along a movement path for one or more cycles in a state where adjustment of temperature of the moving section by the temperature-regulating device is not performed; and a food ingredient temperature-regulating processing procedure of supplying the food ingredient continuously to the moving section, after the temperature-regulating control preparation step, in a state where a temperature-regulating control processing to adjust the temperature of the moving section based on a target temperature-regulating temperature range by a temperature-regulating device is placed in an on state.

According to the present disclosure, it is advantageous to performing a temperature-regulating processing of a food ingredient in a stable manner.

### BRIEF DESCRIPTION OF DRAWINGS

FIG. 1 is a diagram showing a schematic view of an example of a food manufacturing apparatus;

FIG. 2 is a block diagram showing an example of a control configuration of a food manufacturing apparatus;

FIG. 3 is a flowchart showing an example of a food manufacturing method and a food heating method;

FIG. 4 shows an example of detection results of first to third temperature sensors after a moving section has been adjusted to a preliminary temperature;

FIG. 5 is a diagram showing an example of a food manufacturing apparatus to illustrate a temperature-regulating control preparation step;

FIG. 6 shows an example of detection results of first to third temperature sensors in a case where a food manufacturing apparatus is placed in a state shown in FIG. 5;

FIG. 7 is a diagram showing a schematic view of an example of a food manufacturing apparatus to illustrate a temperature-regulating control preparation step;

FIG. 8 shows an example of detection results of first to third temperature sensors in a case where a food manufacturing apparatus is placed in a state shown in FIG. 7;

FIG. 9 shows a diagram showing a schematic view of an example of a food manufacturing apparatus to illustrate a temperature-regulating control preparation step;

FIG. 10 shows an example of detection results of first to third temperature sensors in a case where a food manufacturing apparatus is placed in a state shown in FIG. 9;

FIG. 11 is a diagram showing a schematic view of an example of a food manufacturing apparatus to illustrate a temperature-regulating control preparation step;

FIG. 12 shows an example of detection results of first to third temperature sensors in a case where a food manufacturing apparatus is placed in a state shown in FIG. 11;

FIG. 13 is a flowchart of a food manufacturing method and a food heating method related to a first variant example;

FIG. 14 is a cross-sectional diagram showing a schematic view of an example of a moving section, a heating device and an outer circumference cover member related to a second variant example;

FIG. 15 is a side view showing a schematic view of an example of a moving section, a heating device and an outer circumference cover member related to the second variant example; and

FIG. 16 is a side view showing a schematic view of an example of a moving section and a heating device related to a third variant example.

### DESCRIPTION OF EMBODIMENTS

Below, one embodiment of the present disclosure is described with reference to the drawings.

The following embodiment(s) relates to a food manufacturing apparatus, a food manufacturing method and a food temperature-regulating method where heating (in particular, baking) of a food ingredient is performed, but can be applied also to a food manufacturing apparatus, a food manufacturing method and a food temperature-regulating method where cooling of a food ingredient is performed.

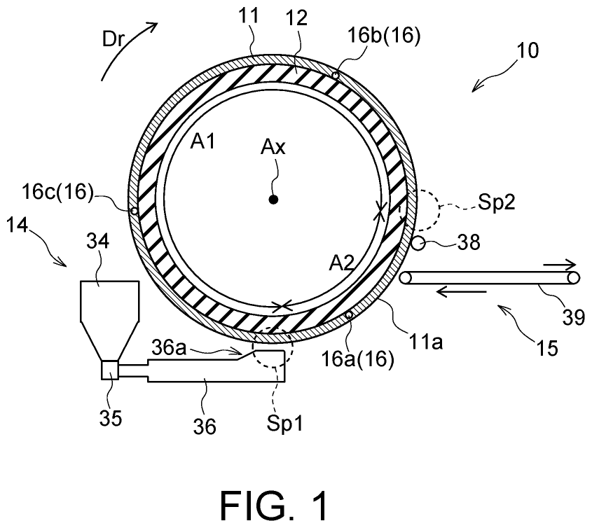

FIG. 1 is a diagram showing a schematic view of an example of a food manufacturing apparatus 10. In FIG. 1, a moving section 11, a heating device (a temperature-regulating device) 12 and temperature sensors 16 (i.e., a first temperature sensor 16a through a third temperature sensor 16c) are shown in cross-section, while a food ingredient supply device 14 and a food ingredient receiving device 15, etc. are shown in appearance.

The food manufacturing apparatus 10 shown in FIG. 1 is an apparatus for performing baking to provide a non-flowable thin-skinned food product from a flowable liquid batter, and comprises a moving section 11, a heating device 12, a food ingredient supply device 14, a food ingredient receiving device 15 and temperature sensors 16. In the following description, both a liquid batter and a thin-skinned food product after baking are referred to as a “food ingredient”.

The moving section 11 is configured as a heating cooking device (a temperature-regulating cooking device) that heats a food ingredient. The moving section 11 shown in the drawing is formed by a heating drum that is capable of rotating in the direction denoted by an arrow “Dr” and includes an endless heating treatment surface (a temperature-regulating treatment surface) 11a that is formed by the outer circumference surface of the heating drum. The moving section 11 continuously rotates and moves about a rotation axis Ax. The moving section 11 repeatedly passes through a first area A1 where the moving section 11 moves with a food ingredient 90 on the moving section 11, and a second area A2 where the moving section 11 moves with no food ingredient 90 on the moving section 11.

The heating device 12 is provided as a temperature-regulating device to adjust the temperature of the moving section 11, and in the present embodiment in particular, the heating device 12 generates heat to heat the moving section 11, thereby adjusting the temperature of the moving section 11 to a target heating temperature range suitable for heating treatment of a food ingredient 90. The target heating temperature range is a temperature range higher than the ambient temperature (normally, the ordinary temperature (5° C. to 35° C.)) and is appropriately determined according to a food ingredient 90. In cases where baking is performed to manufacture a thin-skinned food product from a batter, for instance, the temperature range of 100° C. or more and 150° C. or less or the temperature range of 110° C. or more and 130° C. or less may be used as the target heating temperature range. The target heating temperature range may include a plurality of temperatures or only a specific temperature (i.e., a specific target heat generation temperature).

The heating device 12 shown in the drawing includes a plurality of electric heaters installed inside the moving section 11 to heat the moving section 11 from the inside. The plurality of electric heaters are arranged to cover the entire inner circumference surface of the moving section 11. In the present example, all the electric heaters included in the heating device 12 are energized uniformly, the heat generation temperature of the heating device 12 is adjusted uniformly throughout the entire heating device 12, and the moving section 11 is heated uniformly throughout the entire moving section 11. However, the heating device 12 may be configured to allow energization control with respect to each of the electric heaters, and the heat generation temperature of each of the plurality of electric heaters included in the heating device 12 may be adjusted individually.

The electric heaters used in the heating device 12 are not limited. For instance, an electric heater based on an on-off control method or an electric heater capable of controlling power (voltage and/or current) in a stepless manner (e.g., an AC power regulator equipped with a semiconductor such as a thyristor) can be used in the heating device 12. Incidentally, the heating device 12 may use other heating means (e.g., IH: induction heating).

The heating device 12 may be fixed to a support member, which is not shown in the drawings, to be installed not to be movable or may be installed to be movable, and may be installed to be movable integrally with the moving section 11 for instance. Incidentally, the installation position of the heating device 12 is not limited to the example shown in the drawing, and the heating device 12 may be embedded in the moving section 11 for instance.

The temperature sensors 16 detect the temperature of the moving section 11 (including the heating treatment surface 11a).

The temperature sensors 16 shown in FIG. 1 includes a plurality of sensors (i.e., a first temperature sensor 16a through a third temperature sensor 16c). The first temperature sensor 16a through the third temperature sensor 16c are installed at equal angular intervals around the rotation axis Ax, are partially embedded in the moving section 11, and are provided to turn and move along with the moving section 11. Each of the first temperature sensor 16a through the third temperature sensor 16c detects the temperature of the installation parts of the moving section 11.

The arrangement form and the temperature detection method of the first temperature sensor 16a through the third temperature sensor 16c are not limited. The first temperature sensor 16a through the third temperature sensor 16c may be located entirely outside the moving section 11. The first temperature sensor 16a through the third temperature sensor 16c may be formed by contact-type temperature sensors such as thermocouples and may be provided to contact the inner circumference surface and/or the outer circumference surface of the moving section 11. Alternatively, the first temperature sensor 16a to the third temperature sensor 16c may be formed by non-contact-type sensors such as infrared sensors and may be positioned on the inner circumference surface side and/or the outer circumferential surface side of the moving section 11.

The first temperature sensor 16a through the third temperature sensor 16c do not have to move regardless of the rotation of the moving section 11. In this case, the first temperature sensor 16a through the third temperature sensor 16c detect the temperature of parts of the moving section 11 that pass through detection spots that are assigned to the first temperature sensor 16a through the third temperature sensor 16c, respectively. Further, the number of temperature sensors 16 is not limited to three; four or more temperature sensors 16 may be installed, or one or two temperature sensors 16 may be installed.

At a food ingredient supply spot Sp1, the food ingredient supply device 14 supplies to the moving section 11 a food ingredient 90 based on a food ingredient supply setting amount. In the present embodiment, a food ingredient 90 that is to be supplied to the moving section 11 by the food ingredient supply device 14 is made up of a flowable batter and typically contains flour, rice flour and/or eggs. However, a food ingredient 90 may contain other ingredients in addition to or instead of flour, rice flour and/or eggs. In the present embodiment, the temperature of a food ingredient 90 kept in the food ingredient supply device 14 and the temperature of a food ingredient 90 when being supplied from the food ingredient supply device 14 to the moving section 11 is equal to ambient temperature (normally, ordinary temperature).

The food ingredient supply device 14 shown in the drawing comprises a food ingredient hopper 34, a food ingredient regulator 35, and a food ingredient guide discharge unit 36.

A food ingredient 90 is thrown into the food ingredient hopper 34 by machine or by humans, and the food ingredient hopper 34 can store the food ingredient 90. The food ingredient hopper 34 may have an agitator (not shown) as appropriate, and the ingredient 90 stored in the food ingredient hopper 34 may be stirred by the agitator.

The food ingredient regulator 35 adjusts the amount of food ingredient 90 delivered from the food ingredient hopper 34 to the food ingredient guide discharge unit 36, and thus, adjusts the amount of food ingredient 90 supplied to the moving section 11 from the food ingredient guide discharge unit 36. The specific configuration of the food ingredient regulator 35 is not limited, and for instance, the food ingredient regulator 35 comprises a gear pump.

The food ingredient guide discharge unit 36 includes a food ingredient guide path (not shown) that guides downstream a food ingredient 90 that has been sent from the food ingredient hopper 34 via the food ingredient regulator 35. The food ingredient guide discharge unit 36 includes a food ingredient discharge section 36a that discharges a food ingredient 90 that has been sent through the food ingredient guide path. The food ingredient discharge section 36a may be configured by an end part of the food ingredient guide path or may be provided as a separate body from the food ingredient guide path. By bringing a food ingredient 90, being made to overflow from the food ingredient discharge section 36a, into contact with, at the food ingredient supply spot Sp1, the moving portion 11 (in particular, the heating treatment surface 11a) that is rotating and moving, the food ingredient 90 is supplied to the moving portion 11 in a state of having a thin film shape.

The food ingredient receiving device 15 receives a food ingredient 90 that has taken off from the moving section 11 at a food ingredient delivery spot Sp2. A food ingredient 90 supplied to the moving section 11 is heated and baked while moving, along with the moving section 11, in the first area A1 from the food ingredient supply spot Sp1 towards the food ingredient delivery spot Sp2, and the baked food ingredient 90 is then passed from the moving section 11 to the food ingredient receiving device 15.

The food ingredient receiving device 15 shown in the drawing comprises a food ingredient delivery guide 38 and a delivery conveyor 39. The food ingredient delivery guide 38 guides a food ingredient 90 having separated from the moving section 11, toward the delivery conveyor 39, and may be configured by a scraper, etc. for instance. The delivery conveyor 39 conveys a food ingredient 90 having been placed on the delivery conveyor 39, towards a later stage. The delivery conveyor 39 shown in FIG. 1 is formed by an endless conveyor belt.

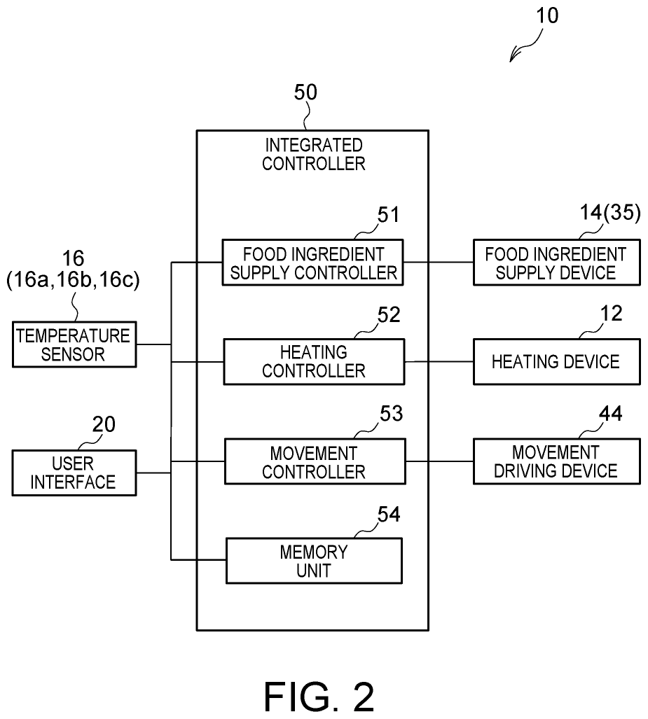

FIG. 2 is a block diagram showing an example of a control configuration of a food manufacturing apparatus 10.

The food manufacturing apparatus 10 of the present embodiment comprises an integrated controller (a control device) 50. The integrated controller 50, which controls other devices included in the food manufacturing apparatus 10, includes a food ingredient supply controller 51, a heating controller (a temperature-regulating control device) 52, a movement controller 53 and a memory unit 54.

The food ingredient supply controller 51 controls the drive of the food ingredient supply device 14 (for instance, the food ingredient regulator 35). The heating controller 52 controls the drive of the heating device 12. The movement controller 53 controls the drive of a movement driving device 44, such as a motor, which provides power to the moving section 11. For instance, the food ingredient supply controller 51, the heating controller 52 and/or the movement controller 53 may include an inverter, and the frequency of the drive current given to each of the controlled objects may be adjusted by the inverter.

The food ingredient supply controller 51, the heating controller 52 and the movement controller 53 are connected to one another and are also connected to the temperature sensors 16, a user interface 20 and the memory unit 54. Each of the food ingredient supply controller 51, the heating controller 52, and the movement controller 53 can send and receive data to and from the other controllers connected thereto, the temperature sensor 16, the user interface 20 and the memory unit 54.

The user interface 20 functions as a user input section where various data and commands are input by users and also as a user output section where various data (e.g., status data) for the food manufacturing apparatus 10 are output. A user may, for instance, input into the user interface 20 a food ingredient supply setting amount indicating the amount of food ingredient 90 being to be supplied to the moving section 11 from the food ingredient supply device 14. A user can also check various data about the food manufacturing apparatus 10 via the user interface 20.

The memory unit 54 stores information such as various data (including programs) and is formed by a storage device based on magnetic, optical, optical-magnetic, or any other write and read method. Devices connected to the memory unit 54 can read and use information stored in the memory unit 54, can update information stored in the memory unit 54, and can store new information in the memory unit 54, as appropriate.

The integrated controller 50 in the present example collectively includes the food ingredient supply controller 51, the heating controller 52, the movement controller 53 and the memory unit 54 that are provided as separate entities from each other. The integrated controller 50 may further include other controllers, memory units, etc. that are not shown in the drawings. Incidentally, any two or more controllers included in the integrated controller 50 may be realized by a common control device. Further, a single control device may function as the food ingredient supply controller 51, the heating controller 52 and the movement controller 53. Further, in the example shown in FIG. 2, the memory unit 54 is provided as a separate unit from other devices, but the memory unit 54 may be provided as part of other devices (e.g., various controllers, etc.).

Incidentally, the integrated controller 50 may control the drive of devices not shown in FIG. 2 and may control the drive of the food ingredient receiving device 15 (e.g., the delivery conveyor 39) for instance.

Next, an example of a food manufacturing method and a food temperature-regulating method (in particular, a food heating method) using the food manufacturing apparatus 10 will be described.

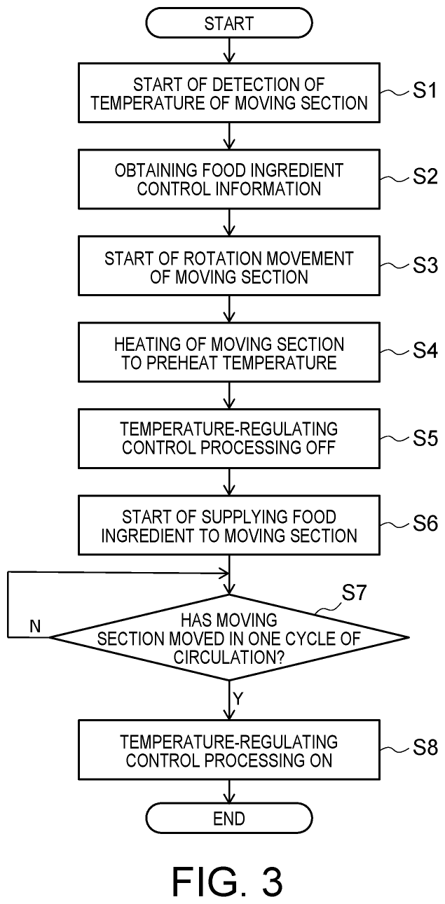

FIG. 3 is a flowchart showing an example of a food manufacturing method and a food heating method.

The heating treatment (a temperature-regulating process) of a food ingredient 90 using the food manufacturing apparatus 10 starts with the entire moving section 11 having the same temperature (typically, ambient temperature (e.g., ordinary temperature)).

Further, detection of the temperature of the moving section 11 by the temperature sensors 16 (i.e., the first temperature sensor 16a through the third temperature sensor 16c) is started (S1 in FIG. 3). The temperature sensors 16 continuously or intermittently detects the temperature of the moving section 11 and transmits the detection results to the integrated controller 50 (for instance, the heating controller 52). The temperature detection and the transmission of the detection results by the temperature sensors 16 are performed continuously throughout the entire steps of the food manufacturing method and the food heating method.

Further, food ingredient control information input by a user via the user interface 20 is obtained by the integrated controller 50 (for instance, the food ingredient supply controller 51, the heating controller 52 and/or the movement controller 53) (S2).

The food ingredient control information includes information about the food ingredient supply setting amount indicating directly or indirectly the amount of food ingredient 90 being to be supplied to the moving section 11 from the food ingredient supply device 14. For instance, the amount of food ingredient 90 supplied to the moving section 11 per unit of time and/or the thickness of a food ingredient 90 placed on the moving section 11 may be the food ingredient supply setting amount. Further, the food ingredient control information may include information other than the food ingredient supply setting amount and may include, for instance, information about the constituent materials and/or moisture contents of a food ingredient 90.

Then, the movement controller 53 drives the movement driving device 44 to start the rotational movement of the moving section 11 (S3).

The specific mode of rotational movement of the moving section 11 is not limited. For instance, the moving section 11 may be rotated at a predetermined rotational speed under the control of the movement controller 53. Further, the movement controller 53 may adaptively determine the rotation speed of the moving section 11 based on the food ingredient supply setting amount, the detection results of the temperature sensors 16 (i.e., the temperature of the moving section 11) and/or other information. The movement controller 53 may control the movement driving device 44 to rotate the moving section 11 at a rotation speed thus determined.

Then, the drive of the heating device 12 is started under the control of the heating controller 52, so that the moving section 11 is heated by the heating device 12 to be adjusted to a preliminary temperature (S4: a preliminary temperature-regulating step).

The heating controller 52 controls the heating device 12 according to the temperature of the moving section 11 detected by the temperature sensors 16 to vary the degree of heating of the moving section 11 by the heating device 12 according to the actual temperature of the moving section 11. In the present embodiment, the amount of heat generation (the amount of energization) of all the electric heaters included in the heating device 12 is adjusted uniformly based on the average value of the detection temperatures of the first temperature sensor 16a through the third temperature sensor 16c. In this manner, the heating device 12 heats the moving section 11 based on a feedback control method. Incidentally, the specific manner of heating of the moving section 11 by the heating device 12 is not limited.

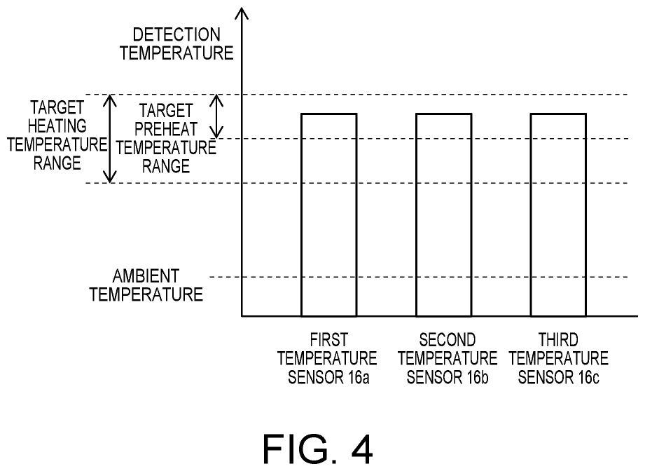

FIG. 4 shows an example of the detection results of the first temperature sensor 16a through the third temperature sensor 16c after the moving section 11 is adjusted to a preliminary temperature.

In the preliminary temperature-regulating step (S4) described above, the entire moving section 11 is uniformly heated by the heating device 12 while a food ingredient 90 is not supplied to the moving section 11. This causes the temperature of the entire moving section 11 to increase uniformly from the ambient temperature toward a target preliminary temperature range. Then, when the first temperature sensor 16a through the third temperature sensor 16c detect that the temperature of the moving section 11 reaches the target preliminary temperature range, the heating device 12 stops heating the entire moving section 11, so that the preliminary temperature-regulating step ends.

Therefore, during the preliminary temperature-regulating step, the moving section 11 is heated in the same manner or in almost the same manner throughout the moving section 11, and the detection results of the first temperature sensor 16a to the third temperature sensor 16c are the same or almost the same as each other. The determination of whether the temperature of the moving section 11 has reached the target preliminary temperature range may be performed based on the average value of the detection temperatures of the first temperature sensor 16a to the third temperature sensor 16c or may be performed based on whether the detection temperature of one or more temperature sensors has reached the target preliminary temperature range.

If the temperature of the moving section 11 falls within the target preliminary temperature range, the moving section 11 is considered to have a preliminary temperature. The target preliminary temperature range may include a plurality of temperatures or only a specific temperature (i.e., a specific preliminary temperature).

The preliminary temperature (the target preliminary temperature range) is a temperature in the target temperature-regulating temperature range described below or a temperature higher than the target temperature-regulating temperature range (i.e., is within or above the target temperature-regulating temperature range). Specifically, the preliminary temperature (the target preliminary temperature range) is a temperature at which a food ingredient 90 supplied to the moving section 11 from the food ingredient supply device 14, in a state where the heating of the moving section 11 by the heating device 12 is stopped, is completely baked before reaching the food ingredient delivery spot Sp2. Therefore, the preliminary temperature (the target preliminary temperature range) is determined according to the heating characteristics of a food ingredient, the characteristics of the moving section 11 (e.g., heat storage characteristics) and the capacity of the heating device 12.

In the example shown in FIG. 4, a part of the target heating temperature range that includes the upper temperature limit, is set as the target preliminary temperature range, but a temperature range that includes a higher temperature than the target heating temperature range may be set as the target preliminary temperature range.

After the preliminary temperature-regulating step is performed in this manner, a temperature-regulating control preparation step is performed under the control of the integrated controller 50. Specifically, under the control of the heating controller 52, the “temperature-regulating control processing to adjust the temperature of the moving section 11 based on the target temperature-regulating temperature range by the heating device 12” is turned off (S5). Further, under the control of the food ingredient supply controller 51, the supplying of a food ingredient 90 from the food ingredient supply device 14 to the moving section 11 is started (S6). Then, under the control of the movement controller 53, the moving section 11 is moved in one cycle of circulation (S7).

As described above, in the temperature-regulating control preparation step, in a state where the temperature-regulating control processing is turned off in such a manner that the temperature of the moving section 11 is not adjusted, the moving section 11 moves one cycle along the movement path while a food ingredient 90 is continuously supplied to the moving section 11. Here, “a state where the temperature-regulating control processing is off” can refer to a general state where the temperature of the moving section 11 is not adjusted. Typically, a state where the integrated controller 50 (e.g., the heating controller 52) itself does not perform the temperature-regulating control processing falls under “a state where the temperature-regulating control processing is off”, but other states may also fall under “a state where the temperature-regulating control processing is off”. For instance, a state where the power of the heating device 12 is turned off and a state where there is no connection between the heating controller 52 and the heating device 12 may also fall under “a state where the temperature-regulating control processing is off”. “A state where the temperature-regulating control processing is off” and/or “a state where the temperature-regulating control processing is on” may be created by the integrated controller 50 (e.g., the heating controller 52) or by an operator.

In the temperature-regulating control preparation step, active temperature adjustment of the moving section 11 (specifically, active heating and cooling of the moving section 11) is not performed, but a food ingredient 90 is continuously supplied to the moving section 11 in a state where a part of the moving section 11 to which the food ingredient 90 is supplied has a temperature within or above the target temperature-regulating temperature range.

Therefore, in the temperature-regulating control preparation step, a food ingredient 90 supplied to the moving section 11 at the food ingredient supply spot Sp1 has been baked before reaching the food ingredient delivery spot Sp2, and is peeled off from the moving section 11 by the food ingredient delivery guide 38 at the food ingredient delivery spot Sp2 and is passed to the food ingredient receiving device 15. In this manner, a food ingredient 90 is removed, at the food ingredient delivery spot Sp2, from a part of the moving section 11 to which the food ingredient 90 has been supplied at the food ingredient supply spot Sp1, and the part of the moving section 11 is in a state where a new food ingredient 90 can be supplied when the part of the moving section 11 then reaches the food ingredient supply spot Sp1 again.

In order to ensure a state where the heating treatment (in the present embodiment, baking) of a food ingredient 90 is possible in the temperature-regulating control preparation step, which does not perform heating of the moving section 11, the moving section 11 is sufficiently preheated in the preliminary temperature-regulating step (S4) described above, which is performed prior to the temperature-regulating control preparation step. Specifically, the target temperature-regulating temperature range and the temperature drop of the moving section 11 in the temperature-regulating control preparation step (S5-S7) are taken into account to set the target preliminary temperature range (the preliminary temperature) described above, and the temperature of the moving section 11 is appropriately adjusted to the target preliminary temperature range (the preliminary temperature) in the preliminary temperature-regulating step. Such setting of a target preliminary temperature range (a preliminary temperature) may be performed by the heating controller 52. The heating controller 52 may set a target preliminary temperature range (a preliminary temperature) based on information input via the user interface 20.

In this manner, in the temperature-regulating control preparation step, the temperature of the moving section 11 is prevented from becoming lower than the target temperature-regulating temperature range, and a food ingredient 90 supplied to the moving section 11 is collected from the moving section 11 in a baked state at the food ingredient delivery spot Sp2.

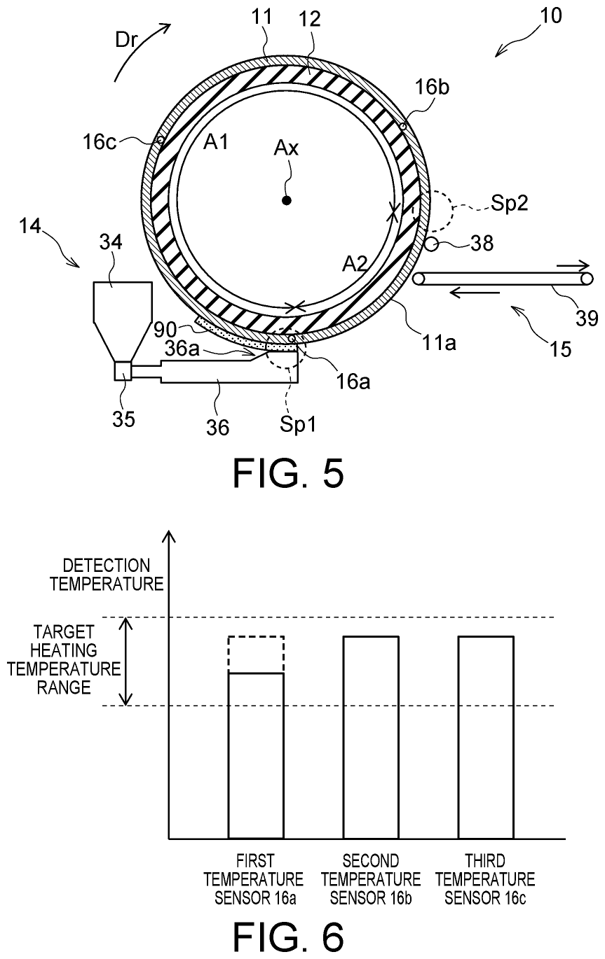

FIGS. 5, 7, 9 and 11 are diagrams showing a schematic view of an example of a food manufacturing apparatus 10 to illustrate the temperature-regulating control preparation step. FIGS. 6, 8, 10 and 12 show an example of detection results of the first temperature sensor 16a to the third temperature sensor 16c when the food manufacturing apparatus 10 is placed in states shown in FIGS. 5, 7, 9 and 11, respectively.

A food ingredient 90 discharged from the food ingredient supply device 14 (the food ingredient discharge section 36a) in the temperature-regulating control preparation step adheres, in a thin film, to the heating treatment surface 11a of the moving section 11, which lowers the temperature of the moving section 11.

In a state shown in FIG. 5 for instance, a food ingredient 90 adheres to a part of the moving section 11 that corresponds to the first temperature sensor 16a and the detection temperature of the first temperature sensor 16a drops (see FIG. 6). On the other hand, since no food ingredient 90 adheres to parts of the moving section 11 corresponding to the second temperature sensor 16b and the third temperature sensor 16c, the detection temperatures of the second temperature sensor 16b and the third temperature sensor 16c do not drop and are higher than the detection temperature of the first temperature sensor 16a.

However, in a state shown in FIG. 5, the temperature of a part of the moving section 11 corresponding to the first temperature sensor 16a (the detection temperature of the first temperature sensor 16a) is lower than the temperature at the beginning of the temperature-regulating control preparation step (the preliminary temperature) but is still within the target heating temperature range (see FIG. 6).

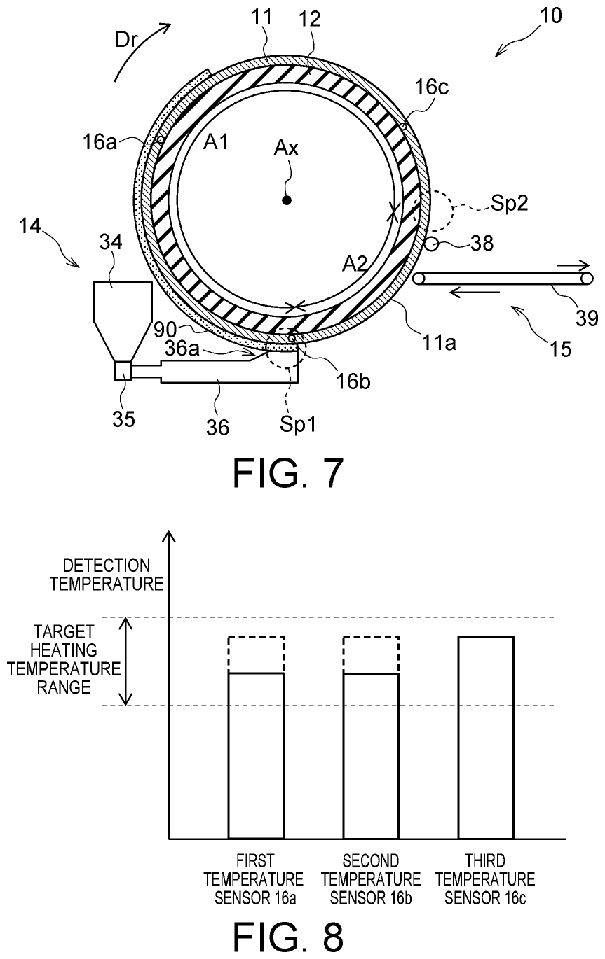

After that, when the moving section 11 rotates and moves to reach a state shown in FIG. 7, a food ingredient 90 adheres also to a part of the moving section 11 corresponding to the second temperature sensor 16b and the detection temperature of the second temperature sensor 16b drops to the same level as the detection temperature of the first temperature sensor 16a (see FIG. 8). On the other hand, since no food ingredient 90 adheres to a part of the moving section 11 corresponding to the third temperature sensor 16c, the detection temperature of the third temperature sensor 16c does not drop and is higher than the detection temperatures by the first temperature sensor 16a and the second temperature sensor 16b.

In a state shown in FIG. 7, the temperatures of parts of the moving section 11 corresponding to the first temperature sensor 16a and the second temperature sensor 16b (i.e., the detection temperatures by the first temperature sensor 16a and the second temperature sensor 16b) are lower than the preliminary temperature but are still within the target heating temperature range.

Incidentally, during the transition from a state shown in FIG. 5 to a state shown in FIG. 7, some of the heat energy stored in the moving section 11 is used for the heating treatment of a food ingredient 90 having been supplied onto the moving section 11. Accordingly, strictly speaking, the temperature of a part of the moving section 11 corresponding to the first temperature sensor 16a may be slightly lower than the temperature of a part of the moving section 11 corresponding to the second temperature sensor 16b. However, in the present embodiment, the heat energy stored in the moving section 11 is very large compared to the thermal energy used for the heating treatment of a food ingredient 90. Further, if the thermal conductivity of the moving section 11 is high, a temperature difference between areas of the moving section 11 is reduced within a short time. Therefore, in a state shown in FIG. 7, the temperature of a part of the moving section 11 corresponding to the first temperature sensor 16a is almost the same as or substantially the same as the temperature of a part of the moving section 11 corresponding to the second temperature sensor 16b.

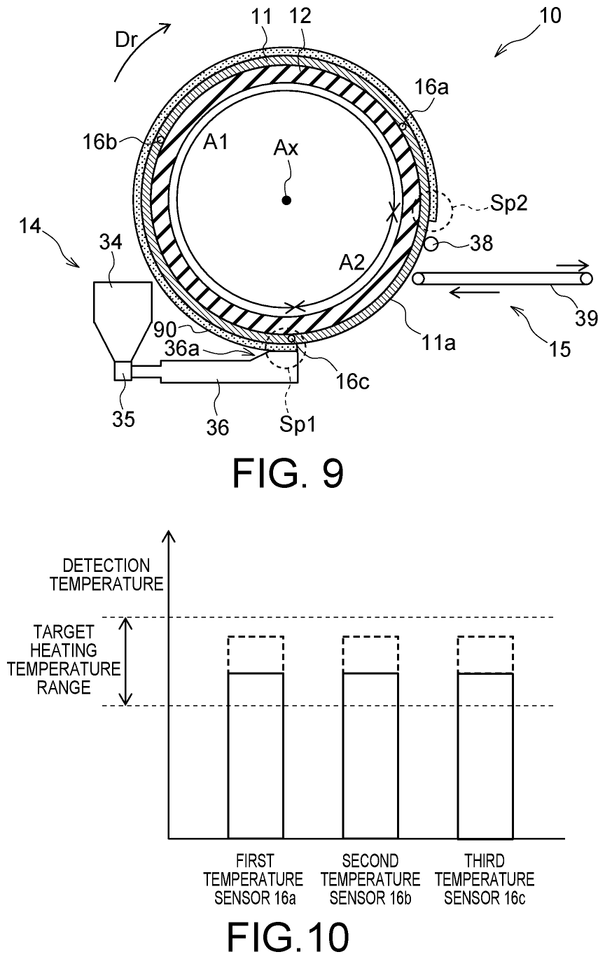

After that, when the moving section 11 rotates and moves to reach a state shown in FIG. 9, a food ingredient 90 adheres also to a part of the moving section 11 that corresponds to the third temperature sensor 16c. Thus, the detection temperature of the third temperature sensor 16c drops to the same level as the detection temperatures of the first temperature sensor 16a and the second temperature sensor 16b (see FIG. 10).

In a state shown in FIG. 9, the temperatures of parts of the moving section 11 corresponding to the first temperature sensor 16a through the third temperature sensor 16c (i.e., the detection temperatures by the first temperature sensor 16a through the third temperature sensor 16c) are lower than the preliminary temperature but are still within the target heating temperature range. Further, the temperature of a part of the moving section 11 corresponding to the first temperature sensor 16a may be slightly lower than the temperature of a part corresponding to the second temperature sensor 16b. Further, the temperature of the part corresponding to the second temperature sensor 16b may be slightly lower than the temperature of the part corresponding to the third temperature sensor 16c. However, the temperatures of the parts of the moving section 11 corresponding to the first temperature sensor 16a through 16c are almost the same as or substantially the same as each other.

In a state shown in FIG. 9, there is a part of the moving section 11 between a part corresponding to the first temperature sensor 16a and a part corresponding to the third temperature sensor 16c to which a food ingredient 90 has never adhered during the temperature-regulating control preparation step. The temperature of this “part to which a food ingredient 90 has never adhered” is higher than the temperature of parts of the moving section 11 corresponding to the first temperature sensor 16a through the third temperature sensor 16c and is almost the same as the preliminary temperature (but strictly speaking, is slightly lower than the preliminary temperature).

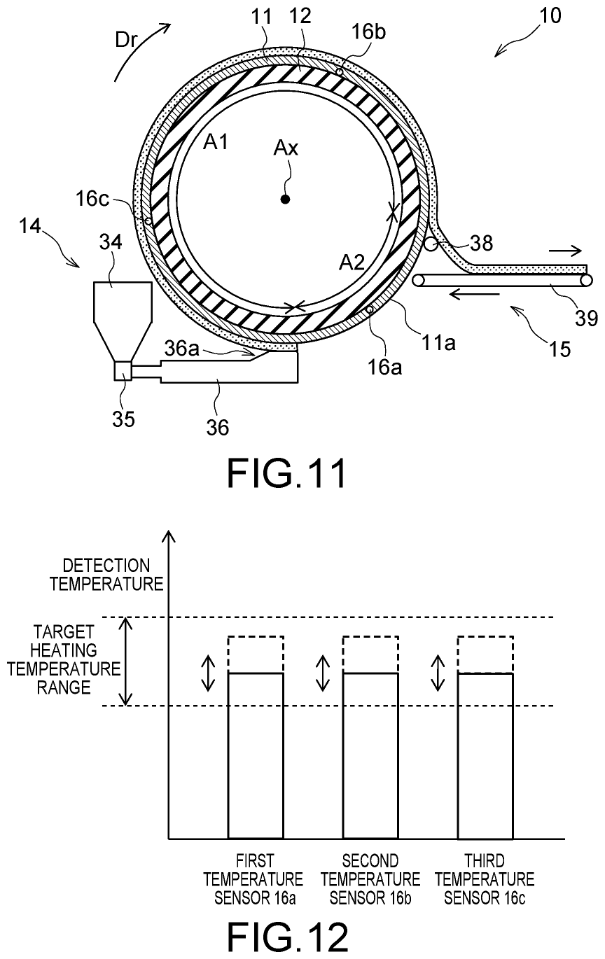

Therefore, the temperature-regulating control preparation step continues until “a part to which a food ingredient 90 has never adhered in the temperature-regulating control preparation step” disappears from the moving section 11 (in particular, the heating treatment surface 11a). In the present embodiment, the temperature-regulating control preparation step continues until the moving section 11 has made exactly one rotation in the temperature-regulating control preparation step and a food ingredient 90 from the food ingredient supply device 14 has been supplied to the entire area of the heating treatment surface 11a (see FIG. 11).

By performing the temperature-regulating control preparation step as described above, it is possible to create “a state where the temperature of the moving section 11 is almost uniform throughout the moving section 11 while a food ingredient 90 is continuously supplied to the moving section 11”.

After the temperature-regulating control preparation step is performed in this manner, a food ingredient temperature-regulating processing step is performed under the control of the integrated controller 50. Specifically, after the temperature-regulating control preparation step, the temperature-regulating control processing is turned on under the control of the heating controller 52 (S8 in FIG. 3), and in a state where the temperature-regulating control processing is on, a food ingredient 90 is continuously supplied to the moving section 11 under the control of the food ingredient supply controller 51 and the movement controller 53. In fact, the rotational movement of the moving section 11 and the supplying of a food ingredient 90 to the moving section 11 are performed in the same way in the temperature-regulating control preparation step and the food ingredient temperature-regulating processing step. Therefore, the processing can seamlessly shift from the temperature-regulating control preparation step to the food ingredient temperature-regulating processing step without interrupting the rotation movement of the moving section 11 and without interrupting the supplying of a food ingredient 90 to the moving section 11.

By going through the temperature-regulating control preparation step described above, the moving section 11 is placed in a state where the entire moving section 11 has almost the same temperature while being receiving the supply of a food ingredient 90 from the food ingredient supply device 14. Therefore, in the food ingredient temperature-regulating processing step, the temperature-regulating control processing to uniformly adjust the temperature of the entire moving section 11 is turned on, in a state where the entire moving section 11 has almost the same temperature. This makes it possible to adjust the temperature of the entire moving section 11 to the target heating temperature range while preventing occurrence of large temperature differences among areas of the moving section 11, thus enabling stable and uniform heating treatment of a food ingredient 90 by the moving section 11.

In particular, in the food ingredient temperature-regulating processing step of the present embodiment, after the temperature-regulating control processing is switched from the off-state to the on-state in a state where the moving section 11 has a temperature in the target temperature-regulating temperature range, a food ingredient 90 is continuously supplied to the moving section 11. This allows a food ingredient 90 to receive a heating treatment at an appropriate temperature by the moving section 11 from the beginning of the food ingredient temperature-regulating processing step.

Further, even if the temperature of the moving section 11 changes as the food ingredient temperature-regulating processing step progresses, the moving section 11 is heated, as appropriate, by the heating device 12 in a state where the temperature-regulating control processing is on. Thus, the temperature of the entire moving section 11 can be continuously maintained within the target heating temperature range suitable for the heating treatment of a food ingredient 90.

Incidentally, while the temperature-regulating control processing is on, the heating device 12 does not necessarily continue to actively heat the moving section 11. Specifically, the heating device 12 does not have to heat the moving section 11 while the moving section 11 has a temperature suitable for the heating treatment of a food ingredient 90. However, in order to continuously maintain the temperature of the moving section 11 within the target heating temperature range, the heating device 12 may actively heat the moving section 11 even when the temperature of the moving section 11 is within the target heating temperature range. In this case, the heating device 12 may appropriately adjust the heating of the moving section 11 in such a manner that the temperature of the moving section 11 does not exceed the target heating temperature range and may temporarily stop the heating of the moving section 11 as appropriate.

Therefore, the heating device 12 may generate heat to heat the moving section 11 from the beginning of the food ingredient temperature-regulating processing step or may not generate heat continuously and not heat the moving section 11 even at the beginning of the food ingredient temperature-regulating processing step.

As described above, at the beginning of the food ingredient temperature-regulating processing step, the temperature of the moving section 11 is in the target temperature-regulating temperature range, and therefore the moving section 11 is in a state of being capable of properly performing heating treatment of a food ingredient 90. On the other hand, when the temperature-regulating control processing is turned on in the food ingredient temperature-regulating processing step, heating of the moving section 11 by the heating device 12 may be started in a state where the temperature of the moving section 11 is outside the target temperature-regulating temperature range or may be started in a state where the temperature of the moving section 11 is in the target temperature-regulating temperature range.

As an example, the heating device 12 may start heat generation when the temperature of the moving section 11 (i.e., detection temperatures by the temperature sensors 16) is lower than a threshold temperature within the target temperature-regulating temperature range. In this example, if the temperature of the moving section 11 (detection temperatures by the temperature sensors 16) at the beginning of the food ingredient temperature-regulating processing step is lower than the threshold temperature, the heating device 12 generates heat from the beginning of the food ingredient temperature-regulating processing step to actively heat the moving section 11. On the other hand, if the temperature of the moving section 11 (detection temperatures by the temperature sensors 16) at the beginning of the food ingredient temperature-regulating processing step is equal to or more than the threshold temperature, the heating device 12 does not generate heat and does not heat the moving section 11 at the beginning of the food ingredient temperature-regulating processing step. In this case, the heating device 12 generates heat to actively heat the moving section 11 at a stage where the temperature of the moving section 11 gradually drops and becomes a temperature below the threshold temperature after the start of the food ingredient temperature-regulating processing step.

On the other hand, in a case where the heating device 12 starts heat generation when the temperature of the moving section 11 (detection temperatures by the temperature sensors 16) is lower than the target temperature-regulating temperature range, the heating device 12 does not heat the moving section 11 because the temperature of the moving section 11 is in the target temperature-regulating temperature range at the beginning of the food ingredient temperature-regulating processing step.

As explained above, according to the apparatus and the method of the present embodiment, in the temperature-regulating control preparation step performed prior to the food ingredient temperature-regulating processing step, a food ingredient 90 is supplied to a whole extent of the moving section 11 (in particular, the heating treatment surface 11a) in a state where the operation of the heating device 12 is stopped. This makes it possible to creating, prior to the food ingredient temperature-regulating processing step, a state where the temperature of the moving section 11 is almost uniform throughout the moving section 11 while a food ingredient 90 is continuously supplied to the moving section 11. As a result, the food ingredient temperature-regulating processing step can be started in a state in which large temperature differences are unlikely to occur between areas of the moving section 11 and in which a food ingredient 90 can be supplied to the moving section 11, which enables heating treatment of a food ingredient 90 to be performed in a stable and uniform manner in the food ingredient temperature-regulating processing step.

It is also possible to adjust the food manufacturing apparatus 10 (e.g., the moving section 11) to a state suitable for the food ingredient temperature-regulating processing step while reducing the number of moving cycles of the moving section 11 in the temperature-regulating control preparation step. Thus, the amount of food ingredient 90 used for adjusting a state of the food manufacturing apparatus 10 (the moving section 11) in the temperature-regulating control preparation step can be reduced, thereby reducing food loss.

In the above-described example, in the temperature-regulating control preparation step, the moving section 11 moves along the movement path for only one cycle, but the moving section 11 may cyclically move along the movement path for one or more cycles while a food ingredient 90 is continuously supplied to the moving section 11 from the food ingredient application device 14.

For instance, the moving section 11 may move cyclically for N cycles (“N” is an integer equal to or greater than 1) while a food ingredient 90 is continuously supplied to the moving section 11, in the temperature-regulating control preparation step. In this case, the same amount of food ingredient 90 is evenly supplied to the heating treatment surface 11a of the moving section 11 over the entire heating treatment surface 11a, which can effectively prevent the occurrence of large temperature differences between areas of the moving section 11. However, the larger the value of N, the greater the temperature drop of the moving section 11 associated with the application of a food ingredient 90, and therefore, a smaller value of N is preferable from a standpoint of reducing energy loss.

In general, in cases where heating of the entire moving section 11 is uniformly adjusted based on temperatures of a plurality of locations of the moving section 11, there is a tendency for uneven temperatures to occur in the moving section 11. For instance, if the entire moving section 11 is heated based on the temperature of a part of the moving section 11 of which the temperature has locally dropped due to the supplying of a food ingredient 90, a part of the moving section 11 to which a food ingredient 90 is not supplied will be excessively heated. As a result, a large temperature difference occurs between areas of the moving section 11 (i.e., between an area to which a food ingredient 90 is supplied and an area to which a food ingredient 90 is not supplied).

If the heating treatment of a food ingredient 90 is performed in a state where there is a large temperature difference between areas of the moving section 11, large unevenness occurs in the heating treatment, making it difficult to perform the heating treatment of the food ingredient 90 in a stable and uniform manner.

Further, if there is a large temperature difference between areas of the moving section 11, it is not easy to properly identify such a large temperature difference. If an operator subjectively starts supplying of a food ingredient to the moving section 11 without objectively grasping a state of unevenness in the temperature of the moving section 11, a food ingredient 90 having undergone uneven heating is continuously produced and the heating treatment quality of a food ingredient 90 does not become stable until the unevenness in the temperature of the moving section 11 is reduced.

A food ingredient 90 having undergone uneven heating may require additional heating treatment, or may be used for an application different from an original application, or may be ultimately discarded. Further, a food ingredient 90 that has undergone improper heating treatment may lead to defects in processing in a later stage, which may consequently result in significant harm.

Further, once a large temperature difference occurs between areas of the moving section 11, it is not easy to heat the moving section 11 to uniform the temperature throughout the moving section 11. In particular, in a case where the heating device 12 heats the entire moving section 11 uniformly as in the present embodiment, it normally takes a long time from a state where a large temperature difference exists between areas of the moving section 11 until the entire moving section 11 reaches a uniform temperature suitable for the heating treatment by adjustment. As the time required for adjusting the entire moving section 11 to a uniform temperature suitable for heating treatment increases, the amount of “food ingredient 90 after heating treatment with uneven heating” also increases.

On the other hand, according to the food manufacturing apparatus 10 and the food manufacturing method (the food temperature-regulating method) of the present embodiment described above, it is possible to effectively suppress uneven temperature of the moving section 11 through a simple device configuration and to perform heating treatment of a food ingredient 90 in a stable and uniform manner. Further, according to the present embodiment, since the occurrence of uneven temperature in the moving section 11 can be suppressed, the processing of reducing temperature unevenness of the moving section 11 itself may be unnecessary. As a result, it is possible to promote “reduction of time” required to adjust the food manufacturing apparatus 10 to a state suitable for heating treatment of a food ingredient 90 and “reduction of the amount of food ingredient 90 having undergone improper heating treatment”.

Incidentally, by dividing the moving section 11 (in particular, the heating treatment surface 11a) into a plurality of zones and assigning a plurality of heating devices to the plurality of zones respectively, it is possible to control the temperature of the moving section 11 on a zone-by-zone basis. In this case, it is possible to reduce temperature unevenness between areas of the moving section 11 on a zone-by-zone basis, but the number of devices tends to increase and heating control tends to become more complex. As a result, the required installation space for the equipment may be larger, the labor required to maintain the equipment may increase, and the probability of occurrence of troubles may be higher.

On the other hand, according to the food manufacturing apparatus 10 and the food manufacturing method (the food temperature-regulating method) of the present embodiment described above, it is not possible to perform the temperature control of the moving section 11 on a zone-by-zone basis, but the rise in the number of devices can be curbed and heating control can be simplified. As a result, space-saving design of the equipment is possible, labor required for maintenance of the equipment can be reduced, and the probability of occurrence of troubles can be kept low.

### First Variant Example

In the present variant example, the same characters are attached to elements that are the same as or correspond to those of the above-described embodiments, and their detailed descriptions are omitted.

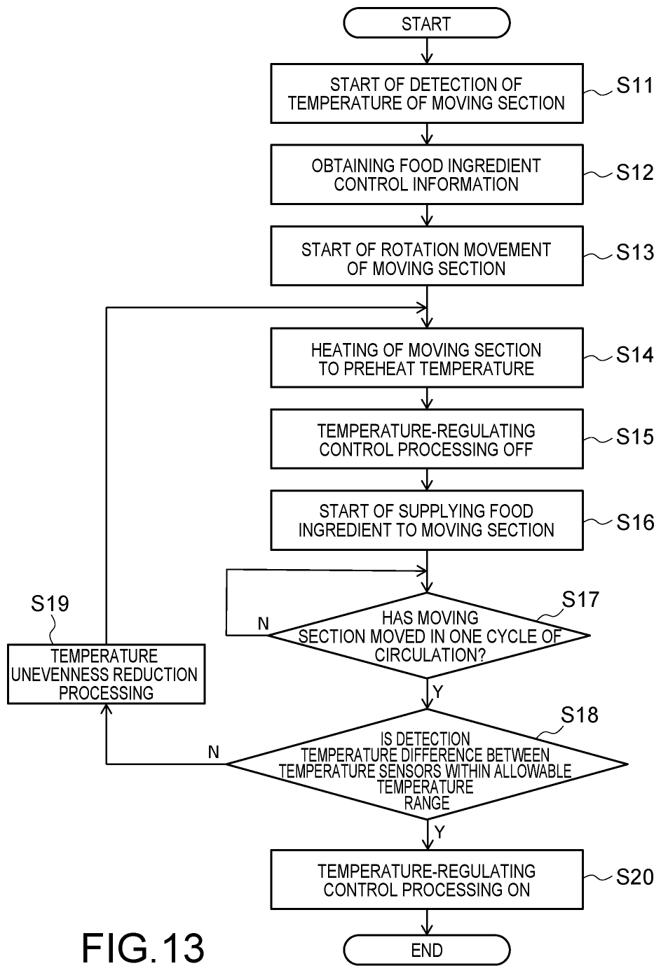

FIG. 13 is a flowchart of a food manufacturing method and a food heating method related to a first variant example.

As one of the conditions for shifting from the temperature-regulating control preparation step to the food ingredient temperature-regulating processing step, temperature differences between a plurality of locations of the moving section 11 may be taken into account. Specifically, in the food ingredient temperature-regulating processing step of the present variant example, the temperature-regulating control processing is switched from the off state to the on state in a state where temperature differences at a plurality of locations of the moving section 11 detected by the temperature sensors 16 are included within an allowable temperature range.

Also in the present variant example, as in the above-described embodiment, the temperature detection of the moving section 11 is started (S11 in FIG. 13), the food ingredient control information is obtained (S12), the rotational movement of the moving section 11 is started (S13), and the preliminary temperature-regulating step is performed (S14).

Then, in the temperature-regulating control preparation step after the preliminary temperature-regulating step, as in the above-described embodiment, the temperature-regulating control processing is turned off (S15), the supplying of a food ingredient 90 to the moving section 11 is started (S16), and the moving section 11 is cyclically moved for only one cycle (S17).

In the temperature-regulating control preparation step of the present variant example, however, the integrated controller 50 (e.g., the heating controller 52) determines whether differences between detection temperatures by the first temperature sensor 16a to the third temperature sensor 16c are within the allowable temperature range (S18).

If detection temperature differences between the first temperature sensor 16a through the third temperature sensor 16c are within the allowable temperature range (Y of S18), the temperature-regulating control processing is turned on (S20) and the food ingredient temperature-regulating processing step is started, as in the above-described embodiment.

On the other hand, if detection temperature differences between the first temperature sensor 16a to the third temperature sensor 16c are not within the allowable temperature range (N of S18), a temperature unevenness reduction processing is performed to reduce a temperature unevenness of the moving section 11 (S19).

The specific process details of the temperature unevenness reduction processing are not limited. For instance, a certain amount of time may be allowed to elapse in a state where the supplying of a food ingredient 90 to the moving section 11 is stopped in order to promote reduction of temperature unevenness of the moving section 11. Alternatively, reduction of temperature unevenness of the moving section 11 may be promoted by locally applying a cooling treatment with a cooling device (not shown) to locally high temperature areas of the moving section 11 or by locally supplying a food ingredient 90 from the food ingredient supply device 14 to locally high temperature areas of the moving section 11. Areas of the moving section 11 that have locally higher temperatures may be determined by the integrated controller 50 (e.g., the heating controller 52) according to the location of a temperature sensor showing a higher detection temperature than the others among the plurality of temperature sensors 16a to 16c, for instance. Further, the configuration and the cooling method of the cooling device are not limited. For instance, the cooling device may supply a cooling medium (e.g., a cooling water or a cooling air) to the heating treatment surface 11a in the second area A2.

After the temperature unevenness reduction processing is performed, the preliminary temperature-regulating step (S14) and subsequent steps are performed again in sequence.

As described above, according to the present variant example, the food ingredient temperature-regulating processing step is started in a state where temperature differences between areas of the moving section 11 are within the allowable temperature range. Therefore, in the food ingredient temperature-regulating processing step, heating treatment of a food ingredient 90 can be performed more reliably by the moving section 11 with smaller temperature unevenness and the temperature-regulating processing of a food ingredient can be performed more stably and uniformly.

### Second Variant Example

In the present variant example, the same characters are attached to elements that are the same as or correspond to those of the above-described embodiments, and their detailed descriptions are omitted.

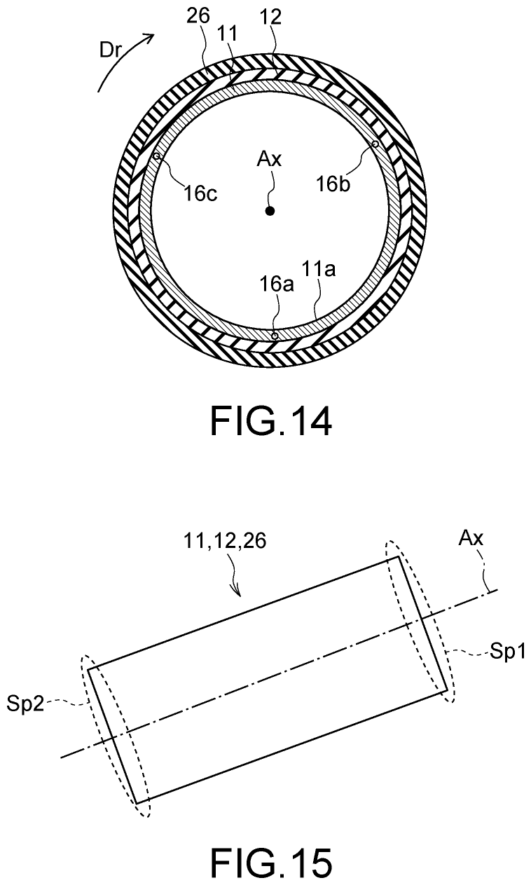

FIG. 14 is a cross-sectional diagram showing a schematic view of an example of a moving section 11, a heating device 12 and an outer circumference cover member 26 related to a second variant example. FIG. 15 is a side view showing a schematic view of an example of a moving section 11, a heating device 12 and an outer circumference cover member 16 related to the second variant example.

The heating treatment surface 11a of the moving section 11 may be formed by the inner circumference surface of a heating drum that forms the moving section 11. Further, a food ingredient 90 supplied to the moving section 11 from the food ingredient supply device 14 may contain solids.

In the present variant example, a heating device 12 is provided to cover the outer circumference surface of a moving section 11 having a tube shape, and an outer circumference cover member 26 is provided to cover the outer circumference surface of the heating device 12. The outer circumference cover member 26 is formed by a heat-insulating member that reduces radiant heat from the heating device 12. The food ingredient supply device 14 (see FIG. 1) provides a food ingredient 90 inside the moving section 11, and the moving section 11 is heated from the outside by the heating device 12. As a result, the food ingredient 90 is heated for cooking on the heating treatment surface 11a formed by the inner circumference surface of the moving section 11.

For instance, as shown in FIG. 15, the moving section 11 having a tube shape may be inclined with respect to the height direction. In this case, openings may be formed at both ends of the moving section 11 in the direction of extension of the rotation axis Ax. An area of the heating treatment surface 11a (i.e., the inner circumferential surface) of the moving section 11 in the vicinity of one end opening may be used as “the food ingredient supply spot Sp1 where a food ingredient 90 is supplied to the moving section 11”. Further, an area of the heating treatment surface 11a in the vicinity of the other end opening may be used as “the food ingredient delivery spot Sp2 where a food ingredient 90 that has been heated for cooking is removed from the moving section 11”. Further, a protrusion portion (not shown) that protrudes from the heating treatment surface 11a and is capable of guiding a food ingredient 90 from the food ingredient supply spot Sp1 towards the food ingredient delivery spot Sp2 in association with the rotation of the moving portion 11 (for instance, a protrusion portion extending in a helical shape) may be provided on the heating treatment surface 11a.

Also in the present variant example, the integrated controller 50 (in particular, the heating controller 52) controls the heating device 12 to perform the temperature-regulating control preparation step and the food ingredient temperature-regulating processing step, so that heating cooking of a food ingredient 90 can be performed in a stable and uniform manner.

### Third Variant Example

In the present variant example, the same characters are attached to elements that are the same as or correspond to those of the above-described embodiments, and their detailed descriptions are omitted.

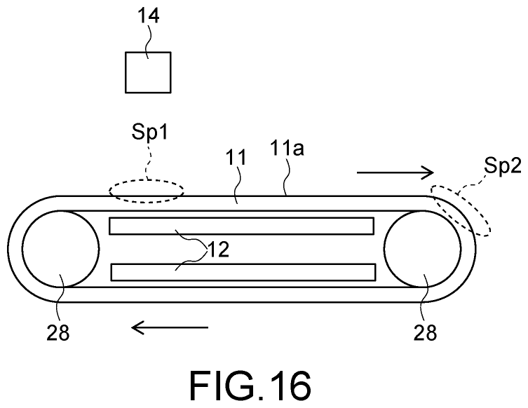

FIG. 16 is a side view showing a schematic view of an example of a moving section 11 and heating devices 12 related to a third variant example.

The moving section 11 may be formed by a conveyor belt. A food ingredient 90 that is supplied to the moving section 11 from the food ingredient supply device 14 may include solids.

The moving section 11 shown in FIG. 16 is formed by an endless belt made of metal (e.g., a wire mesh belt or a steel belt) supported in a strained state by two drive shafts 28. The heating treatment surface 11a is formed by the surface of the moving section 11 that faces outward. The heating device 12 is provided inside the moving section 11. The food ingredient supply device 14 of the present example places a food ingredient 90 (e.g., a solid food ingredient) on the heating treatment surface 11a from above, and the moving section 11 is heated from the inside by the heating device 12.

Also in the present variant example, the integrated controller 50 (in particular, the heating controller 52) controls the heating device 12 to perform the temperature-regulating control preparation step and the food ingredient temperature-regulating processing step, so that heating cooking of a food ingredient 90 can be performed in a stable and uniform manner.

### Other Variant Examples

A cooling device (not shown) may be provided instead of the heating device 12. The temperature-regulating processing (i.e., the cooling treatment) of a food ingredient 90 may be performed by cooling the moving section 11 with a cooling device driven under the control of the integrated controller 50 (e.g., a cooling controller (not shown)).

A heat insulating member (not shown) that reduces the effect of radiant heat on the food ingredient supply device 14, may be provided between the food ingredient supply device 14 (e.g., the food ingredient guide discharge unit 36) and the heating device 12. In this case, heating of a food ingredient 90 inside the food ingredient supply device 14 (e.g., inside the food ingredient guide discharge unit 36) can be prevented, effectively avoiding damage to the quality of a food ingredient 90 in the food ingredient supply device 14. Incidentally, the heat insulating member can include all members that are capable of reducing radiant heat, and can also include so-called heat shielding members that reflect radiant heat.

### Food Ingredients to which the Food Manufacturing Apparatus, the Food Manufacturing Method and the Food Heating Method can be Applied

Food ingredients 90 to which the above-mentioned food manufacturing apparatus 10, food manufacturing method and food temperature-regulating method can be applied are not limited. The food manufacturing apparatus 10, the food manufacturing method, and the food temperature-regulating method are capable of performing temperature-regulating cooking (i.e., heating cooking and/or cooling cooking) of any type of food ingredient 90. Further, the material state of a food ingredient 90 during temperature-regulating cooking is not limited. The food manufacturing apparatus 10, the food manufacturing method, and the food temperature-regulating method can perform temperature-regulating cooking of a food ingredient 90 in a liquid state, a food ingredient 90 in a solid state and a food ingredient 90 in another state.

Batter that is a raw material of a baked thin-skinned food product (skins used for a shumai being a type of dumpling, a jiaozi being a type of dumpling, a spring roll, a burrito, a tacos, and a crepe, etc.) and other paste-like food ingredients (such as cheese) that has an indefinite shape and has fluidity may be supplied, as a food ingredient 90, to the moving section 11 from the food ingredient supply device 14. Further, solid food ingredients (e.g., hamburgers, etc.) to be heated for cooking may be supplied, as food ingredients 90, to the moving section 11 from the food ingredient supply device 14. Further, a fluid food ingredient to be cooled for cooking (e.g., chocolate, etc.) may be supplied, as a food ingredient 90, to the moving section 11 from the food ingredient supply device 14.

The present disclosure is not limited to the embodiments and variant examples described above. Various modifications may be added to each element of the embodiments and variant examples described above. Further, the configurations of the embodiments and the variant examples described above may be combined in whole or in part.

The technical categories embodying the above-described technical ideas are not limited. For instance, the above-described technical ideas may be embodied by a computer program that causes a computer to execute one or more procedures (steps) included in the above-described methods. Further, the above technical ideas may be embodied by a computer-readable non-transitory recording medium in which such a computer program is recorded. [Additional notes]

As is clear from the above, the present disclosure includes the following aspects.

### (Aspect 1)

A food manufacturing method including:
a temperature-regulating control preparation step of supplying a food ingredient continuously to a moving section during the moving section moving cyclically along a movement path for one or more cycles in a state where adjustment of temperature of the moving section is not performed; and
a food ingredient temperature-regulating processing step of supplying the food ingredient continuously to the moving section, after the temperature-regulating control preparation step, in a state where a temperature-regulating control processing to adjust the temperature of the moving section based on a target temperature-regulating temperature range by a temperature-regulating device is placed in an on state.

### (Aspect 2)

The food manufacturing method as defined in aspect 1,
wherein the temperature-regulating device heats the moving section, and
wherein the food ingredient is heated by the moving section.

### (Aspect 3)

The food manufacturing method as defined in aspect 2,
wherein in the temperature-regulating control preparation step, the food ingredient is continuously supplied to the moving section in a state where the moving section has a temperature within or above the target temperature-regulating temperature range, and
wherein in the food ingredient temperature-regulating processing step, the food ingredient is continuously supplied to the moving section after the temperature-regulating control processing is switched to an on state in a state where the moving section has a temperature with the target temperature-regulating temperature range.

### (Aspect 4)

The food manufacturing method as defined in any one of aspects 1 to 3, wherein in the food ingredient temperature-regulating processing step, the temperature-regulating control processing is switched to an on state in a state where a difference in temperatures at a plurality of locations of the moving section detected by a temperature sensor is included an allowable temperature range.

### (Aspect 5)

The food manufacturing method as defined in any one of aspects 1 to 4, wherein the moving section performs rotation movement about a rotation axis.

### (Aspect 6)

A food temperature-regulating method including:
a temperature-regulating control preparation step of supplying a food ingredient continuously to a moving section during the moving section moving cyclically along a movement path for one or more cycles in a state where adjustment of temperature of the moving section is not performed; and
a food ingredient temperature-regulating processing step of supplying the food ingredient continuously to the moving section, after the temperature-regulating control preparation step, in a state where a temperature-regulating control processing to adjust the temperature of the moving section based on a target temperature-regulating temperature range by a temperature-regulating device is placed in an on state.

### (Aspect 7)

A food manufacturing apparatus comprising:
a moving section;
a temperature-regulating device that adjusts temperature of the moving section;
a food ingredient supply device that supplies a food ingredient to the moving section; and
a temperature-regulating control device that controls the temperature-regulating device,
wherein the temperature-regulating control device controls the temperature-regulating device to perform:
a temperature-regulating control preparation step of supplying the food ingredient continuously to the moving section during the moving section moving cyclically along a movement path for one or more cycles in a state where adjustment of temperature of the moving section by the temperature-regulating device is not performed; and
a food ingredient temperature-regulating processing step of supplying the food ingredient continuously to the moving section, after the temperature-regulating control preparation step, in a state where a temperature-regulating control processing to adjust the temperature of the moving section based on a target temperature-regulating temperature range by the temperature-regulating device is placed in an on state.

### (Aspect 8)

A program for causing a computer to execute:
a temperature-regulating control preparation procedure of supplying a food ingredient continuously to a moving section during the moving section moving cyclically along a movement path for one or more cycles in a state where adjustment of temperature of the moving section by the temperature-regulating device is not performed; and
a food ingredient temperature-regulating processing procedure of supplying the food ingredient continuously to the moving section, after the temperature-regulating control preparation step, in a state where a temperature-regulating control processing to adjust the temperature of the moving section based on a target temperature-regulating temperature range by a temperature-regulating device is placed in an on state.

### (Aspect 9)

A control device controlling a food manufacturing apparatus comprising a moving section, a temperature-regulating device that adjusts temperature of the moving section, and a food ingredient supply device that supplies a food ingredient to the moving section,
wherein the control device controls the food manufacturing apparatus to perform:
a temperature-regulating control preparation step of supplying the food ingredient continuously to the moving section during the moving section moving cyclically along a movement path for one or more cycles in a state where adjustment of temperature of the moving section by the temperature-regulating device is not performed; and
a food ingredient temperature-regulating processing step of supplying the food ingredient continuously to the moving section, after the temperature-regulating control preparation step, in a state where a temperature-regulating control processing to adjust the temperature of the moving section based on a target temperature-regulating temperature range by the temperature-regulating device is placed in an on state.

1. A food manufacturing method including:
a temperature-regulating control preparation step of supplying a food ingredient continuously to a moving section during the moving section moving cyclically along a movement path for one or more cycles in a state where adjustment of temperature of the moving section is not performed; and
a food ingredient temperature-regulating processing step of supplying the food ingredient continuously to the moving section, after the temperature-regulating control preparation step, in a state where a temperature-regulating control processing to adjust the temperature of the moving section based on a target temperature-regulating temperature range by a temperature-regulating device is placed in an on state.

2. The food manufacturing method as defined in claim 1,
wherein the temperature-regulating device heats the moving section, and
wherein the food ingredient is heated by the moving section.

3. The food manufacturing method as defined in claim 2,
wherein in the temperature-regulating control preparation step, the food ingredient is continuously supplied to the moving section in a state where the moving section has a temperature within or above the target temperature-regulating temperature range, and
wherein in the food ingredient temperature-regulating processing step, the food ingredient is continuously supplied to the moving section after the temperature-regulating control processing is switched to an on state in a state where the moving section has a temperature with the target temperature-regulating temperature range.

4. The food manufacturing method as defined in claim 1, wherein in the food ingredient temperature-regulating processing step, the temperature-regulating control processing is switched to an on state in a state where a difference in temperatures at a plurality of locations of the moving section detected by a temperature sensor is included an allowable temperature range.

5. The food manufacturing method as defined in claim 1, wherein the moving section performs rotation movement about a rotation axis.

6. A food temperature-regulating method including:
a temperature-regulating control preparation step of supplying a food ingredient continuously to a moving section during the moving section moving cyclically along a movement path for one or more cycles in a state where adjustment of temperature of the moving section is not performed; and
a food ingredient temperature-regulating processing step of supplying the food ingredient continuously to the moving section, after the temperature-regulating control preparation step, in a state where a temperature-regulating control processing to adjust the temperature of the moving section based on a target temperature-regulating temperature range by a temperature-regulating device is placed in an on state.

7. A food manufacturing apparatus comprising:
a moving section;
a temperature-regulating device that adjusts temperature of the moving section;
a food ingredient supply device that supplies a food ingredient to the moving section; and
a temperature-regulating control device that controls the temperature-regulating device,
wherein the temperature-regulating control device controls the temperature-regulating device to perform:
a temperature-regulating control preparation step of supplying the food ingredient continuously to the moving section during the moving section moving cyclically along a movement path for one or more cycles in a state where adjustment of temperature of the moving section by the temperature-regulating device is not performed; and
a food ingredient temperature-regulating processing step of supplying the food ingredient continuously to the moving section, after the temperature-regulating control preparation step, in a state where a temperature-regulating control processing to adjust the temperature of the moving section based on a target temperature-regulating temperature range by the temperature-regulating device is placed in an on state.

8. (canceled)
